(19) United States
(12) Patent Application Publication
(10) Pub. No.: US 2017/0284407 A1
(43) Pub. Date: Oct. 5, 2017

(54) Automatic Inlet Swirl Device for Turbomachinery

(71) Applicant: Michael Xuwang Cao, Murrysville, PA (US)

(72) Inventor: Michael Xuwang Cao, Murrysville, PA (US)

(21) Appl. No.: 15/084,430

(22) Filed: Mar. 29, 2016

(51) Int. Cl. F04D 27/00; F04D 29/44; F04D 17/10

(52) U.S. Cl. CPC F04D 27/002; F04D 17/10; F04D 29/441; F05B 2240/123

(57) ABSTRACT

A turbomachinery assembly has a fluid inlet positioned to facilitate the passage of a fluid. The turbomachinery inlet may need a device which can produce inlet swirl or no swirl based on the operation conditions. In this invention, an inlet swirl device is designed to produce the inlet swirl with only one asymmetric automatic valve. No actuator is needed to control the valve. The valve opening is automatic adjusted based on the inlet flow rate. An inlet vane ring assembly is disposed adjacent the inlet and includes a plurality of vanes in the circumferential direction. The vane ring is not movable, but can produce different magnitudes of swirl.

### BACKGROUND

The present invention relates to an inlet swirl device to control the flow and the pressure ratio of turbomachinery or other devices which require inlet swirl. More particularly, the present invention relates to an inlet swirl that is adjustable to vary flow through the turbomachinery or other related devices.

Most previous art of inlet swirl devices has an inlet axial vane to produce the swirl, as shown in FIG. 1 prior art 55. The inlet axial vane is rotated through an external actuator to control the compressor inlet swirl magnitude. The large vane angle will produce large losses, assume vane angle is zero degrees when the vane is in the axial direction. The traditional design also needs an actuator system to operate the vane. This invention incorporates a circumferential airfoil device as shown in FIG. 2 103 to produce swirl. The swirl magnitude was controlled by an inlet guide disk as shown in FIG. 3 216 which automatically adjusts according to the magnitude of inlet swirl. No external actuator is needed.

The turbocompressor provides a compressor assembly having a fluid inlet positioned to facilitate the passage of a fluid. The turbocompressor assembly includes a compressor housing defining a compressor inlet and a rotating vane or impeller rotatably supported at least partially within the compressor housing. A fluid treatment member is disposed adjacent the compressor housing and between the compressor inlet and the inducer portion and an inlet swirl device disposed adjacent the compressor inlet and includes a plurality of vanes in the bypass flow area and a rotating disc in the mainflow duct. All the vanes are not movable. The swirl magnitude will automatically adjust based on the inlet flow rate, for example, if the compressor needs a large flow rate, the main duct disc will be fully opened and almost all the flow goes through the main duct, so the bypass flow is almost zero. The fluid inlet swirl is minimal. When the compressor only needs small flow, the inlet disc is almost fully closed, due to very small aerodynamic force. Because the inlet disc is almost fully closed, the majority of the flow passes through the bypass duct, which produces the maximum amount of swirl. This invention provides an inlet swirl device which can automatically produce the swirl without any actuation system based on the needs of the turbomachinery. This invention can be used in any turbomachinery device or system, for example, turbocharger compressors, aircraft engine compressors, centrifugal compressors, or any other system which requires an inlet swirl device.

### DESCRIPTION OF THE DRAWINGS

FIG. 1 is a sectional view through the centerline of a prior art compression stage of a prior art centrifugal gas compressor.

FIG. 2 is a view of the compressor with the current inlet swirl device.

FIG. 3 is a view of the bypass vent and the main flow duct.

FIG. 4 is a view of the inlet guide disc.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

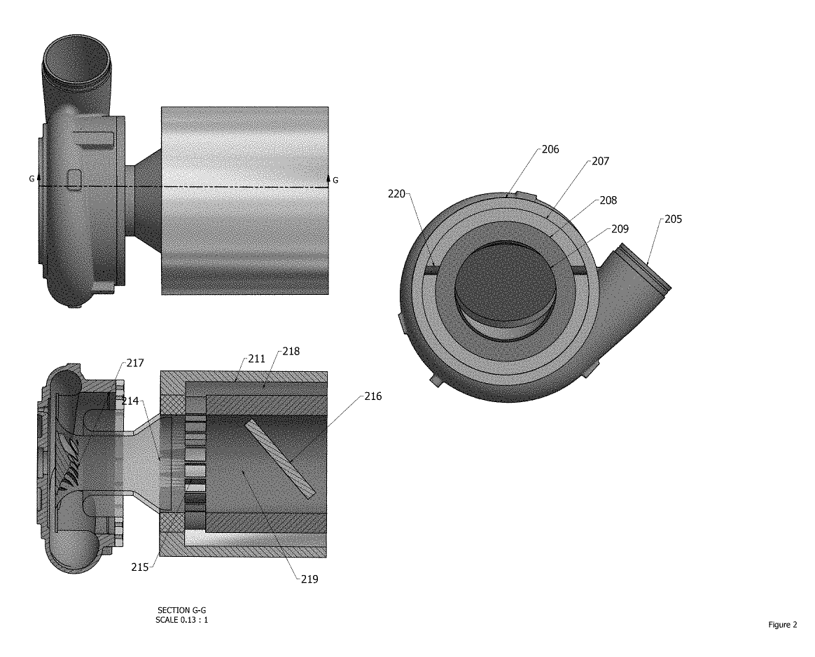

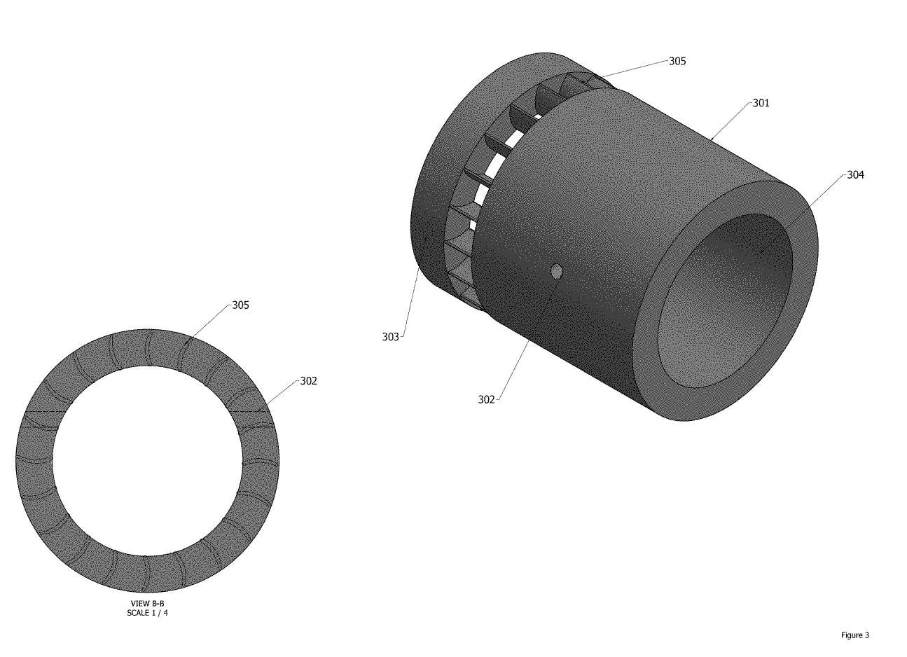

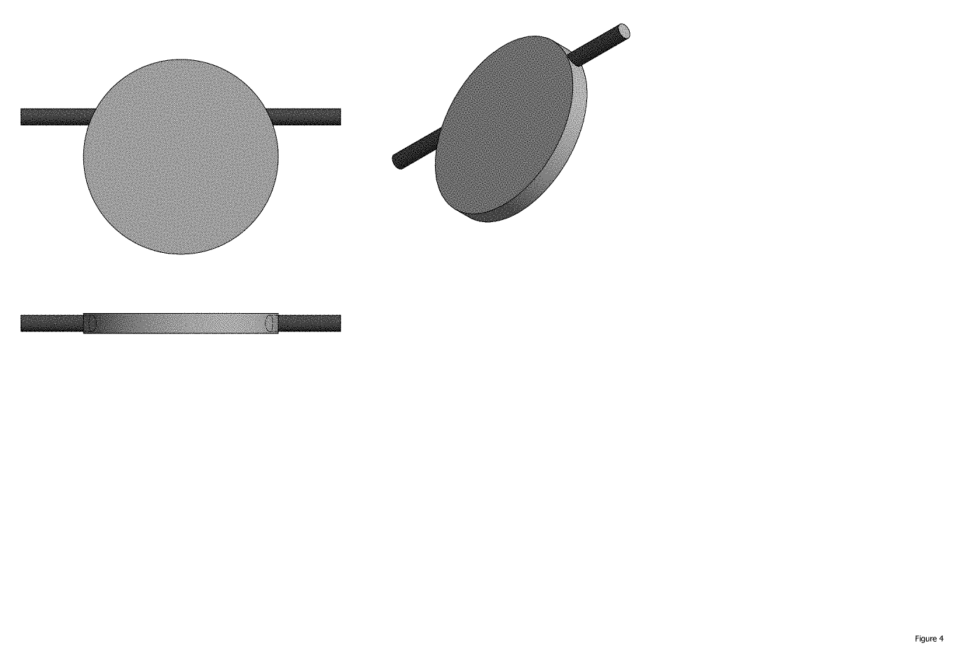

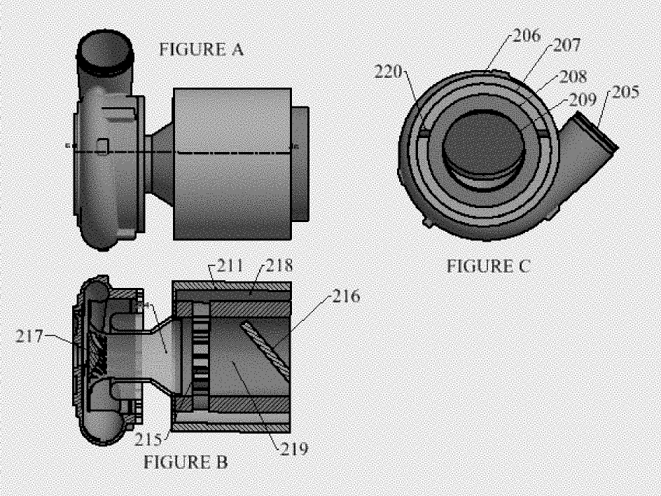

FIG. 1 is prior art. Notice that the inlet swirl of the compressor was produced by axial inlet guide vane 55. The guide vane is located in the inside of the main flow path. The swirl magnitude was achieved by turning the inlet guide vane 55 to a different angle. The strong swirl was produced by the large angle of the inlet guide vane rotating away from the inlet flow direction. It means that to produce large swirl will cause large losses due to the vane flow stalling. The inlet guide vane axis is perpendicular to compressor wheel 45 rotational axis.

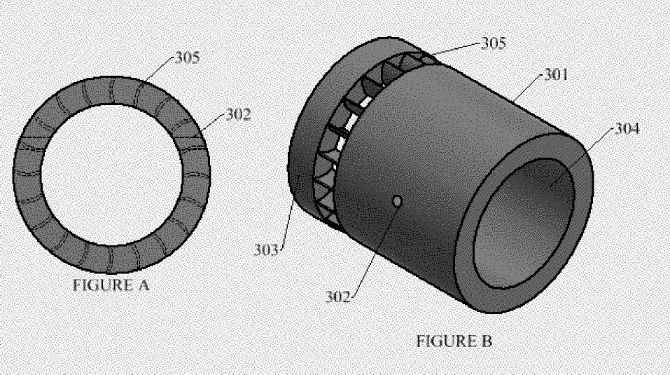

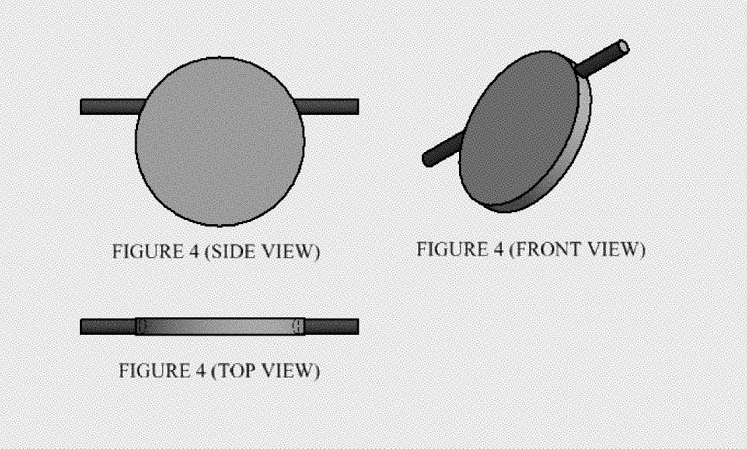

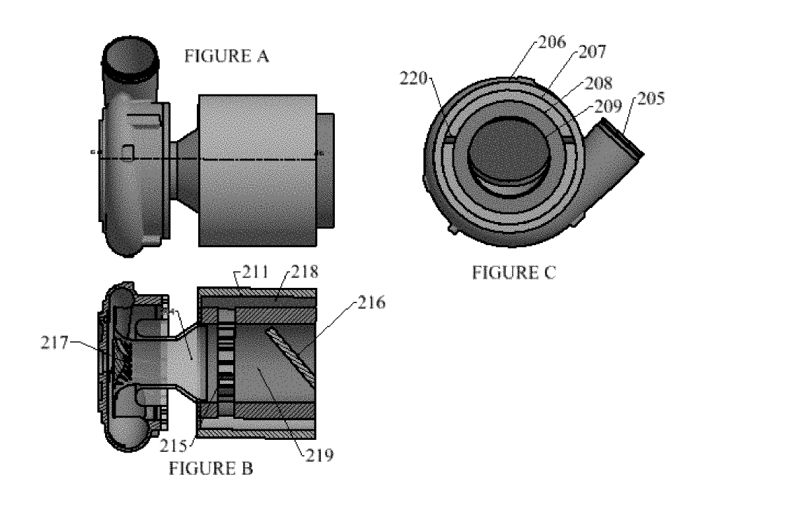

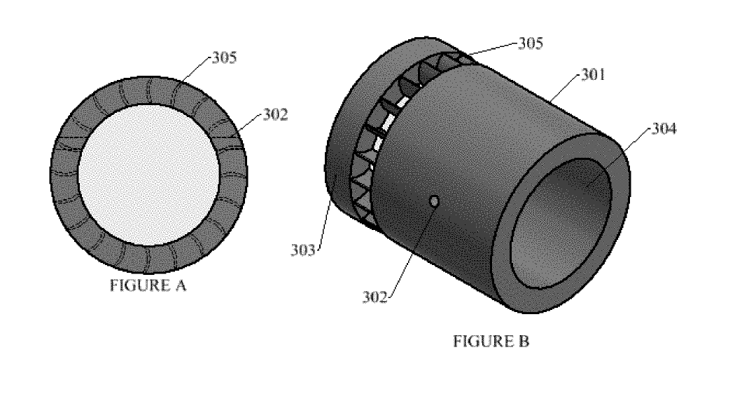

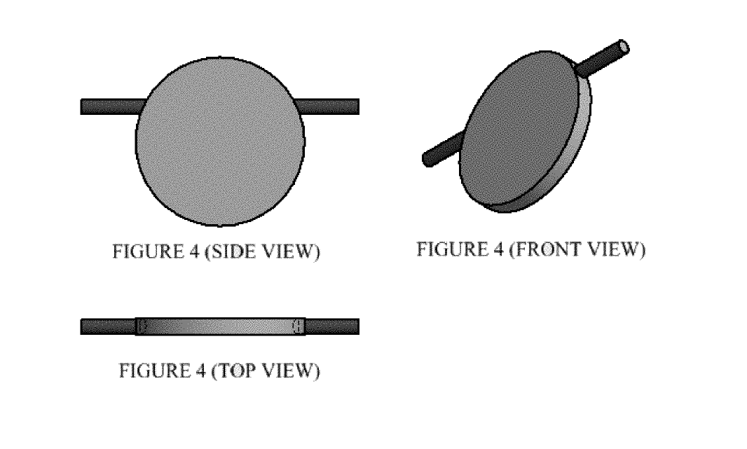

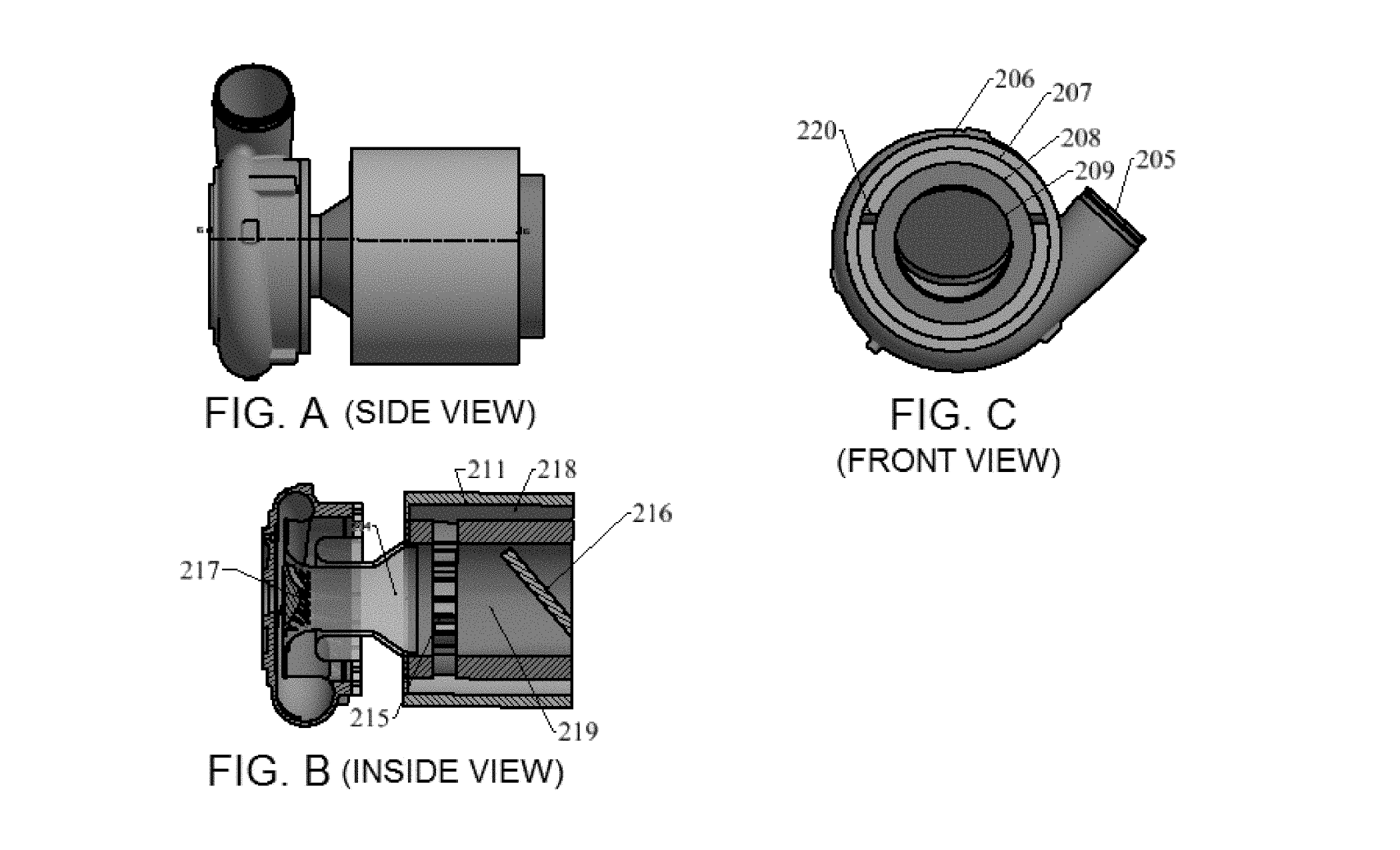

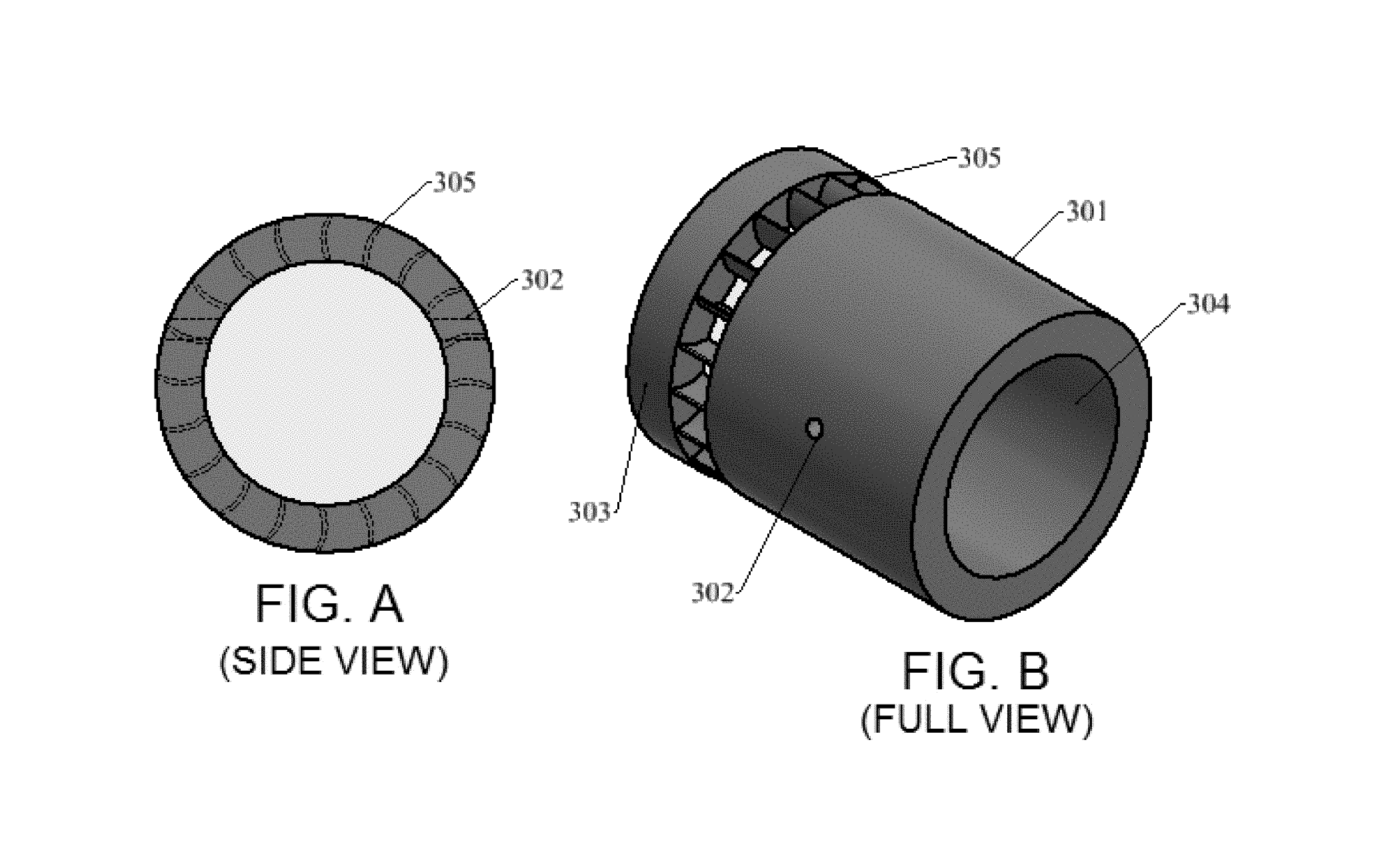

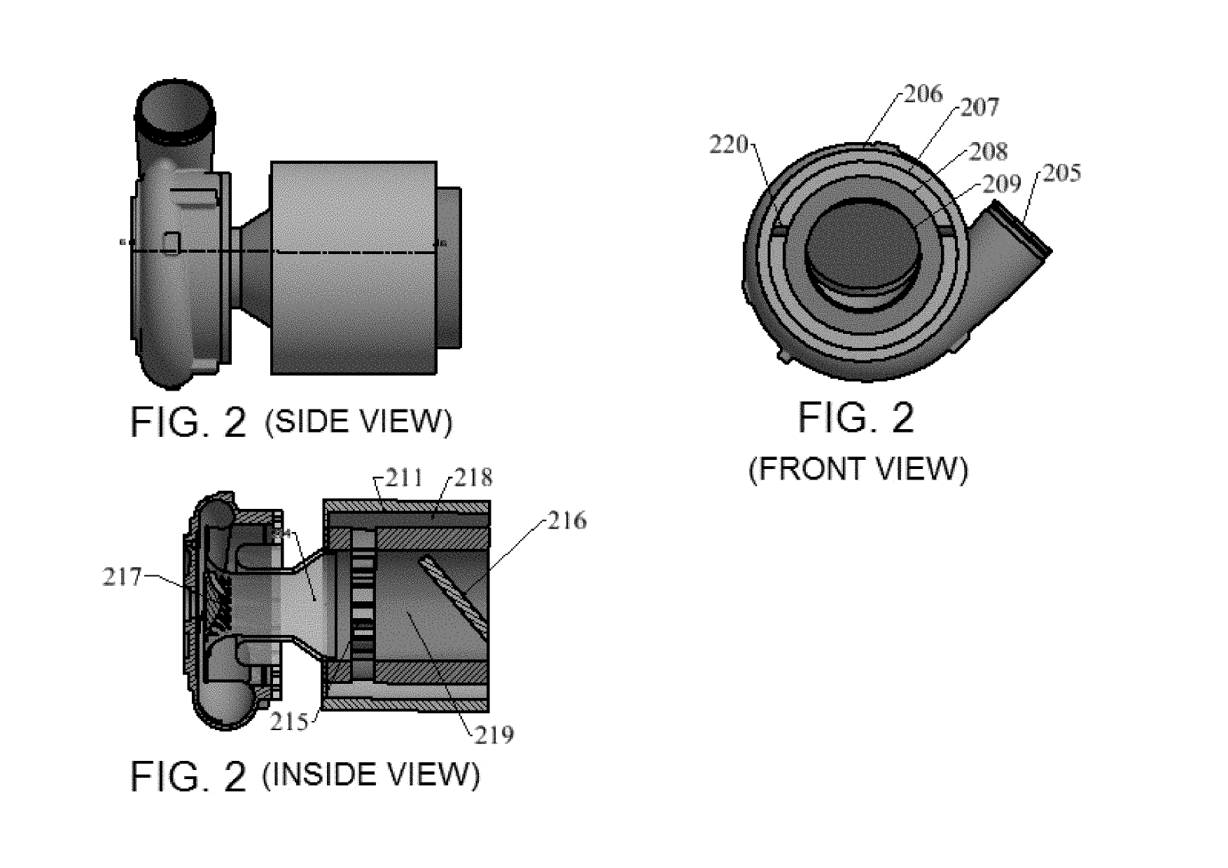

FIGS. 1 and 2 illustrate turbomachinery that include prior art and current inlet swirl devices 215, 55. Specifically, FIG. 1 illustrates a prior art compressor, while FIG. 2 illustrates a turbomachinery that includes an inlet swirl device. When the main design requirement of an inlet swirl device is to produce flow based on the compressor flow requirements, the most effective approach is to design the swirl device to meet the operation need with minimum losses. Consequently, to provide the needed flow with minimum losses, the inlet swirl device must be designed to be as aerodynamic and as effective as possible.

It should be noted that FIGS. 1 and 2 are referred to herein as illustrating a turbomachinery of any sort. As such, the term turbomachinery when used herein may refer to turbomachinery of any kind such as centrifugal compressors, aircraft engine compressors, or turbocharger compressors and turbines.

Before proceeding with the discussion of the construction illustrated in FIGS. 2-4, some discussion of turbomachinery operation is necessary. The compression cycle in turbocompressors is based on the transfer of kinetic energy from rotating blades to a fluid. The rotating blades impart kinetic energy to the fluid by changing its momentum and velocity. The fluid momentum is then converted into pressure energy by decreasing the velocity of the fluid in stationary diffuser's and downstream collecting systems. The performance of turbomachinery depends on the conditions of the gas at the inlet of each compression stage and the operating speed of the turbomachinery stages. In dynamic compression there is an interdependent relationship between capacity and compression ratio. Accordingly, a change in fluid capacity, in turbomachinery, is generally accompanied by a change in the compression ratio. Also, a change in the temperature of the fluid at the intake of a turbomachinery yields the same effects, in terms of volumetric flow and discharge pressure, as does the opening and closing of an inlet throttling device.

The function of a compressor is to supply to a receiving system or process, a required amount of gas at a certain rate and at a pre-determined discharge pressure. The rate at which the compressed fluid is utilized by the receiving system or process at least partially determines the pressure at which the fluid is supplied. Accordingly, as the demand for fluid decreases, the pressure in the receiving system increases. In response, preferred compressor controls operate to decrease the amount of fluid being compressed, while still maintaining the pre-determined operating pressure (discharge pressure) to the receiving system or process.

One of the approaches to control the output of the turbomachinery in response to the demand of the process is to alter the pressure at the inlet of the first compression stage impeller. To enhance the performance of a turbomachinery, the same approach can also be applied to any intermediate stages of compression. One method to control the capacity of a centrifugal compressor is to utilize a throttling device such as an inlet valve that produces a variable pressure drop. As the valve closes, a greater pressure drop develops, thus requiring the turbomachinery to generate a greater pressure ratio to maintain the discharge pressure at the prescribed operating value of the receiving process. Accordingly, throttling the inlet (i.e., closing the valve) reduces the volumetric capacity of the compressor. The regulation approach that solely utilizes an inlet throttling device is feasible up to the maximum stable pressure of the turbomachinery. Beyond this point, a blow-off valve (not shown) on the discharge section of the turbomachinery may be required to relieve the excess flow to maintain the required discharge pressure in the process without inducing unstable operation of the turbomachinery near the maximum achievable discharge pressure.

One such throttling device includes a single disc which rotates about an axis perpendicular to the axis of the compressor's inlet flow. This type of throttling device is similar to a butterfly valve. A valve encompassing a single rotating disc is effective in inducing the required pressure drop. However, the disc produces an un-coordinated turbulent gas flow pattern that negatively affects the aerodynamic performance of the rotating impeller, especially when the valve is only a few pipe diameter lengths away from the impeller intake or inducer.

A relatively better design for a throttling device includes multiple rotating vanes as shown in FIG. 1. The throttling device includes multiple vanes and is generally referred to as an inlet guide vane throttling device or IGV. The flow leaving the inlet guide vane has a more coordinated velocity pattern than in the case of the single-disc throttling valve, thus reducing the amount of un-recoverable energy inherent in the throttling process. One of the additional benefits of the inlet guide vane, especially in the transition region between the fully closed and the fully open position of the vanes, is that a rotational momentum (swirl) is imparted to the stream of gas leaving the inlet guide vane device. Moreover, a proper sense of rotation of the vanes also improves the approach of the flow to the impeller inducer, thus further enhancing the effectiveness and efficiency of compressor flow regulation, The vanes could also be over-rotated past the fully open position with the effect of actually increasing the pumping capacity of a dynamic compressor.

The currently most efficient prior art design involves an IGV. However, the IGV in the flow path will produce friction loss and vane blockage. Especially when the IGV closes to produce the swirl, the vanes will normally have large incident angle which causes flow separation. This flow separation will produce a large flow loss. Furthermore, the IGV rotation needs an actuation system which also needs energy to operate. This operating system not only causes energy loss, but also causes the cost of the compression system to rise, as the actuation system uses several motors to rotate the IGV vanes. The current invention solves these issues by utilizing an automatically operating asymmetrical disc with a stationary vane system in the secondary flow paths.

FIGS. 2-4 illustrate aspects of a compressor that solves many of the problems associated with prior art constructions including that shown in FIG. 1. Before proceeding, it should be understood that while FIGS. 2-4 are described as they relate to a compressor, one of ordinary skill in the art will realize that FIGS. 2-4 could be applied to one or more stages of a multi-stage compressor or other turbomachinery. As such, the invention should not be limited to single stage compressors, nor should it be limited to multi-stage compressors.

The impeller 217 suctions the gas into the compressor and through a compressor inlet 214. Gas flow through the impeller 217 and other components increases in pressure and discharges through the compressor discharge pipe 205. The compressor inlet normally requires swirl at a low flow condition. The inlet swirl device illustrated in FIGS. 2 to 4 includes a secondary flow path 218 and a main flow path 219. The main flow path also includes an asymmetric automatically adjusting disc. The secondary flow path has many fixed vanes that produces the swirl necessary. The flow from main flow path 219 and the flow from secondary flow path 218 will mix at the compressor inlet before going inside of the impeller. When the inlet gas flow rate is high, the asymmetric disc valve 216 will be fully opened, allowing almost all of the inlet flow to pass through the main inlet 219. The flow passing through the secondary flow path is minimalized, therefore, the inlet swirl entering the compressor is at a minimum. On the other hand, when the compressor needs small flow, the gas flow rate is low, therefore not allowing the disc valve to open due to the gravity of the disc, and consequently directing almost all flow through the secondary flow path. If the majority of the flow passes through the secondary flow path, the gas entering the compressor will have large amounts of swirl.

FIG. 2 illustrates the compressor with the current swirl device. There are two different inlets through which inlet swirl passes through. The cross-section area ratio between the main inlet 219 and the secondary inlet 218 is about 0.7-0.9 dependent on the compressor swirl requirements. That is for large turn down requirements for the compressor needing smaller area ratios. For the smaller turn down requirements, the large ratio is selected.

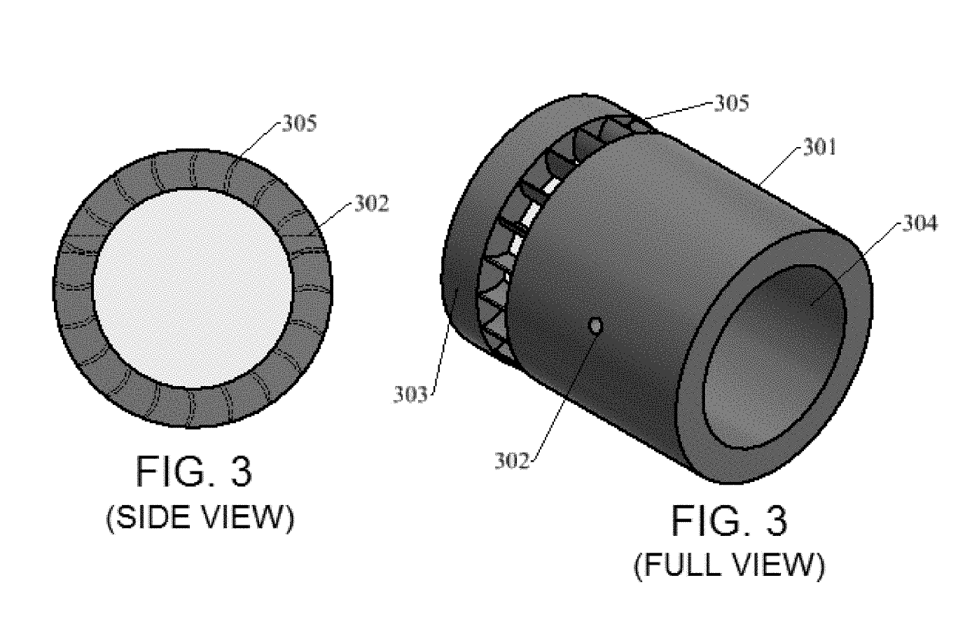

FIG. 3 illustrates the swirl vane device including plural vanes 305 to provide swirl. The plural number of vanes are located at the end of the secondary flow path. The vane orientation can be vertical or have angles less than 90 degrees, The secondary flow 218 flows parallel to the main flow 219, The airflow from the secondary flow path turns 90 degrees at the end to enter the vanes, or, alternatively, turns less than 90 degrees (not shown) to lessen the resistance that is produced from the 90 degree turn. The vanes produce the swirl against the impeller rotational direction due to the vane camber. The more flow that enters the vanes, the stronger the flow swirl will be. This swirl flow mixes together with the main flow to produce the swirl for the compressor inlet. The magnitude of the swirl depends on the percentage of the flow passing through the secondary flow path.

FIG. 4 illustrates the asymmetric disc valve. The valve rotating shaft position and disc thickness are built carefully to make sure the largest flow can turn the valve horizontally with minimum resistance for the main flow and it can also be closed when the flow rate is less than a certain value. The shaft and pipe contact point needs to contain minimal friction to ensure that the disc valve can easily open and close by aerodynamic force. The open magnitude of the valve depends on the aerodynamic force and the aerodynamic force is dependent on the amount of flow passing through the main flow path. The shaft is not in the center of the circle. Instead, it is slightly above the center in order to ensure that the valve may be closed when the flow rate is less than 10-20% of the designed flow rate. This will ensure that when the compressor is working at a low flow rate, the flow will enter the secondary flow path instead of the main flow path.

The arrangement illustrated herein solves the problem of the IGV vane mounted in the flow path due to the large swirl at IGV when the IGV is set to a small angle. Another problem that is solved is that the IGV vanes required an actuation system to move. The problems being solved allows for the IGV to operate aerodynamically and with minimal losses. This also allows the IGV to operate without an actuation system.

Thus, the invention provides, among other things, a highly efficient swirl system. This swirl system solves several problems that are in current IGV systems, making it more efficient, advanced, and low-cost than current swirl systems due in part to the lack of a need for an actuation system and the IGV not being mounted in the flow path.

1. A swirl device having a main flow path and a secondary flow path to provide inlet swirl to the turbocompressor, the swirl device comprising:
a main inlet swirl path and a secondary inlet swirl path

2. The main flow path of claim 1 has an asymmetric valve, able to be automatically adjusted to certain openings based on the compressor inlet flow volume.

3. The secondary flow path of claim 1 has a plurality of camber vanes to produce swirl.

4. The plural vanes are located at the end of the secondary flow path of claim 1, able to be up to 90 degrees or vertical to the main flow path, also able to be less than 90 degrees to allow the secondary flow and the main flow to mix better.

5. The secondary flow path of claim 1 joining with the main flow path can be 90 degrees or less.

6. The cross section area of the secondary flow path of claim 1 is smaller than the cross section of the main flow path area, typically, the cross section of the secondary flow path is about 20 to 30 percent of the cross section area of the main flow path.

7. The vanes are fixed to the secondary flow path, thus no actuation system is needed.
